(19) United States
(12) Patent Application Publication
(10) Pub. No.: US 2014/0249950 A1
(43) Pub. Date: Sep. 4, 2014

(54) STORE SYSTEM

(71) Applicant: TOSHIBA TEC KABUSHIKI KAISHA, Tokyo (JP)

(72) Inventor: Masatsugu Fukuda, Shizuoka-ken (JP)

(73) Assignee: TOSHIBA TEC KABUSHIKI KAISHA, Tokyo (JP)

(21) Appl. No.: 14/180,482

(22) Filed: Feb. 14, 2014

(30) Foreign Application Priority Data
Mar. 4, 2013 (JP) 2013-042157

(51) Int. Cl. G06Q 20/20

(52) U.S. Cl. CPC G06Q 20/208
USPC 705/23

(57) ABSTRACT

In accordance with first embodiment, a store system comprises an image capturing apparatus configured to optically capture an image through an image capturing window; a display for customer configured to be selectively arranged in a horizontal or vertical manner at a side opposite to a side where the image capturing window is arranged to display the display data; a determination unit configured to determine whether the display for customer is placed vertically or horizontally; a sales registration unit configured to execute a sales registration processing in response to an image captured by the image capturing apparatus; and a display content changing unit configured to change, in response to a determination result based on the determination unit, the display data of the sales registration processing carried out by the sales registration unit displayed on the display for customer.

### CROSS-REFERENCE TO RELATED APPLICATION

This application is based upon and claims the benefit of priority from Japanese Patent Application No. 2013-042157, filed Mar. 4, 2013, the entire contents of which are incorporated herein by reference.

### FIELD

Embodiments described herein relate to a store system.

### BACKGROUND

In a supermarket and the like, a shopper puts displayed commodities in a shopping basket or a cart and brings the commodities to a register counter where the checkout job is carried out by a shop clerk.

A barcode scanner serving as one example of an image reading apparatus is arranged at the center of the register counter nearby a customer path. A commodity sales data processing apparatus such as a POS (Point Of Sales) terminal and the like for carrying out a price settlement processing with a shopper is arranged at the exit side of the register counter. The image reading apparatus and the commodity sales data processing apparatus are used in the checkout job.

A scanner for optically reading a barcode attached to a commodity is installed in the barcode scanner. A reading window is arranged at the front side of the scanner. A shop clerk stands at the front side of the reading window when a commodity is read. Further, a display for customer is arranged at the back side (the standing position side of a shopper) opposite to the side where the reading window is arranged.

A shop clerk stands at a position facing to a shopper across the register counter, and holds the commodities brought by the shopper over the reading window in sequence to read the barcode attached to each commodity. At this time, the information such as a commodity name, commodity priced and the like specified based on the barcode read from each commodity is displayed on a display. The shopper confirms the consistency between the information such as the commodity name, commodity priced and the like displayed on the display for customer and the commodity held over the reading window.

### BRIEF DESCRIPTION OF THE DRAWINGS

FIG. 1 is a perspective view illustrating the whole constitution of a POS system according to a first embodiment;

FIG. 2 is a perspective view illustrating a state where an image reading apparatus is viewed from a side opposite to the side where an image capturing window is arranged;

FIG. 3 is a block diagram illustrating an electric connection of an image reading apparatus;

FIG. 4 is a block diagram illustrating an electric connection of a POS terminal;

FIG. 5 is a functional block diagram illustrating functional components of a POS terminal;

FIG. 6 is a flowchart illustrating one example of a flow of a sales registration processing;

FIG. 7 is a front view illustrating a display example in a case where a display for customer is placed vertically; and

FIG. 8 is a front view illustrating a display example in a case where a display for customer is placed horizontally.

### DETAILED DESCRIPTION

In accordance with first embodiment, a store system comprises an image capturing apparatus, a display for customer, a determination unit, a sales registration unit and a display content changing unit. The image capturing apparatus optically captures an image through an image capturing window. The display for customer is selectively arranged in a horizontal or vertical manner at a side opposite to the side where the image capturing window is arranged to display the display data. The determination unit determines whether the display for customer is placed vertically or horizontally. The sales registration unit executes a sales registration processing in response to an image captured by the image capturing apparatus. The display content changing unit changes, in response to a determination result based on the determination unit, the display data of the sales registration processing carried out by the sales registration unit displayed on the display for customer.

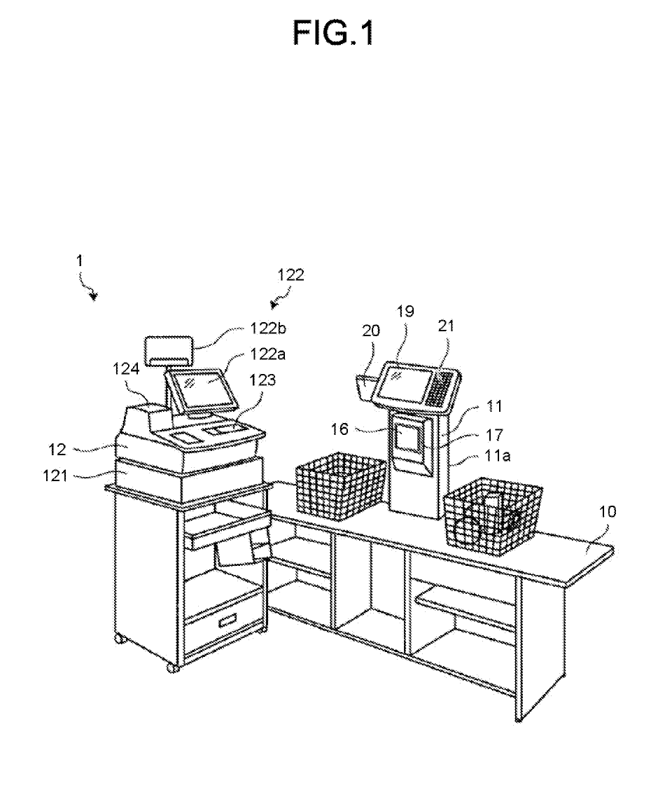

The present embodiment is described below with reference to accompanying drawings. Herein, FIG. 1 is a perspective view illustrating the whole constitution of a POS system 1 according to the embodiment.

As shown in FIG. 1, the POS (Point Of Sales) system 1 serving as a store system comprises an image reading apparatus 11 serving as a vertical scanner and a POS terminal 12 serving as a commodity sales data processing apparatus for executing a sales registration processing in response to an image captured by the image reading apparatus 11. The image reading apparatus 11 is vertically arranged in the approximate center of a sacker table 10 on which shopping baskets are arranged. Further, the POS terminal 12 is arranged nearby one end part of the sacker table 10. The image reading apparatus 11 and the POS terminal 12 are connected to be capable of communicating with each other through a transmission path (not shown). That is, the image reading apparatus 11 and the POS terminal 12 constitute a store system.

The POS terminal 12 executes a sales registration processing including a checkout processing based on various data of commodities purchased by a shopper. The POS terminal 12 is arranged above a drawer 121 which stores coins and bills in such a manner that the money can be taken out from or put in the drawer freely. The POS terminal 12 comprises two displays 122 (122a, 122b) for operator and customer, an input apparatus 123 including a keyboard or mode key, and a receipt printer 124. The display 122 and the input apparatus 123 constitute a user interface which has an information input function of inputting information by a user and an information output function of outputting information for a user.

The image reading apparatus 11 comprises an image capturing apparatus 17, a keyboard 21, a display 19 having a touch panel consisting of a LCD (Liquid Crystal Display), a display for customer 20 serving as a display for customer consisting of a LCD, and the like. The image capturing apparatus 17 optically captures, through an image capturing window 16 which is an opening on a housing 11a and faces to an operator, an image of a code symbol (barcode or two-dimensional code and the like) attached to a commodity or an object image of the whole commodity or a part of a commodity. The keyboard 21 includes various keys for registering a commodity which cannot be registered using the code symbol or the object image. The display 19 displays a name, a price and the like of a registered commodity for an operator in response to the sales registration processing carried out by the POS terminal 12.

Herein, the object recognition is described. The object recognition is a technology of specifying (recognizing) an object according to a feature amount obtained from the appearance of the object captured by the image capturing apparatus 17. The POS terminal 12 extracts the appearance feature of a commodity serving as an imaging subject from the image (object image) captured by the image capturing apparatus 17 as feature amount, and specifies (recognizes) the commodity serving as an imaging subject by comparing the extracted feature amount with the feature amount (data for comparison) of a standard commodity which is prepared in advance. The appearance feature of a commodity refers to a shape, a color, a surface concave-convex situation and the like.

The display for customer 20 is arranged at the back side of the housing 11a, that is, the side opposite to the side where the image capturing window 16 is arranged, and displays a name, a price and the like of a registered commodity for a shopper in response to the sales registration processing carried out by the POS terminal 12.

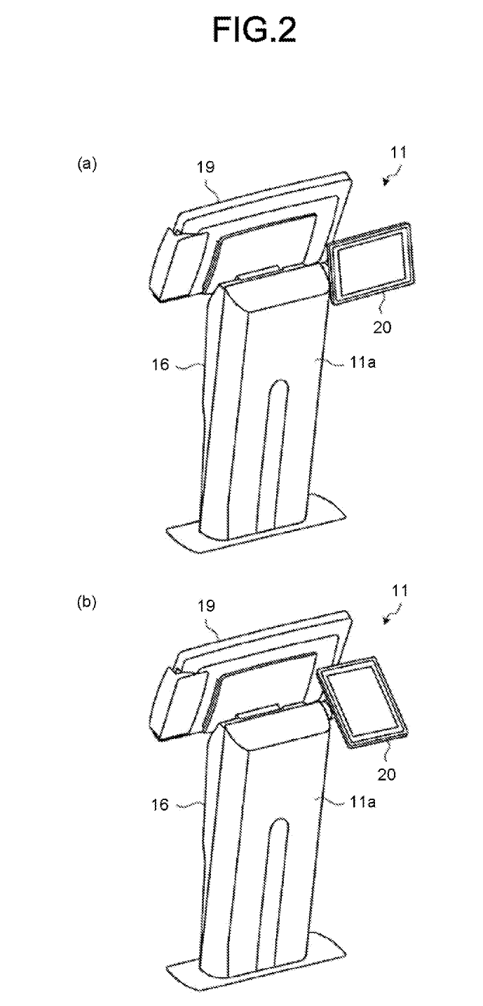

FIG. 2 is a perspective view illustrating a state where the image reading apparatus 11 is viewed from a side (standing position side of a shopper) opposite to the side where the image capturing window 16 is arranged. As shown in FIG. 2(a) and FIG. 2(b), the image reading apparatus 11 can selectively arranges the rectangular-shaped display for customer 20 in a horizontal or vertical manner seen from a shopper. FIG. 2(a) illustrates an example where the display for customer 20 is horizontally arranged seen from a shopper, and FIG. 2(b) illustrates an example where the display for customer 20 is vertically arranged seen from a shopper. Herein, the vertical manner is defined as an arrangement position where the length in the vertical direction is longer than that in the horizontal direction. The horizontal manner is defined as an arrangement position where the length in the horizontal direction is longer than that in the vertical direction. In the following description, the display for customer 20 can be placed horizontally or vertically through rotation.

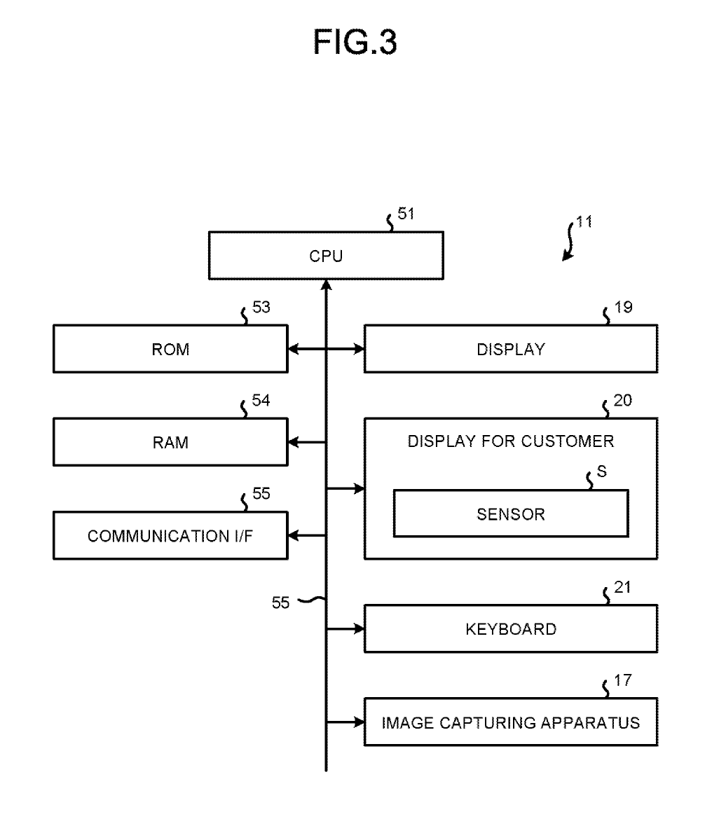

The electric connection of the image reading apparatus 11 is described below. FIG. 3 is a block diagram illustrating the electric connection of the image reading apparatus 11. As shown in FIG. 3, the image reading apparatus 11 mounts a CPU (Central Processing Unit) 51 serving as a control main body. A ROM (Read Only Memory) 53, a RAM (Random Access Memory) 54, a communication interface (I/F) 55, the image capturing apparatus 17, the keyboard 21, the display 19 and the display for customer 20 are connected with the CPU 51 through a bus line 52. The POS terminal 12 is connected with the communication interface (I/F) 55.

Further, the display for customer 20 comprises a sensor S for determining whether the display for customer 20 is placed vertically or horizontally. For example, a vibration type gyroscope serving as a measuring device for detecting an angle and an angular velocity of an object may be used as the sensor S.

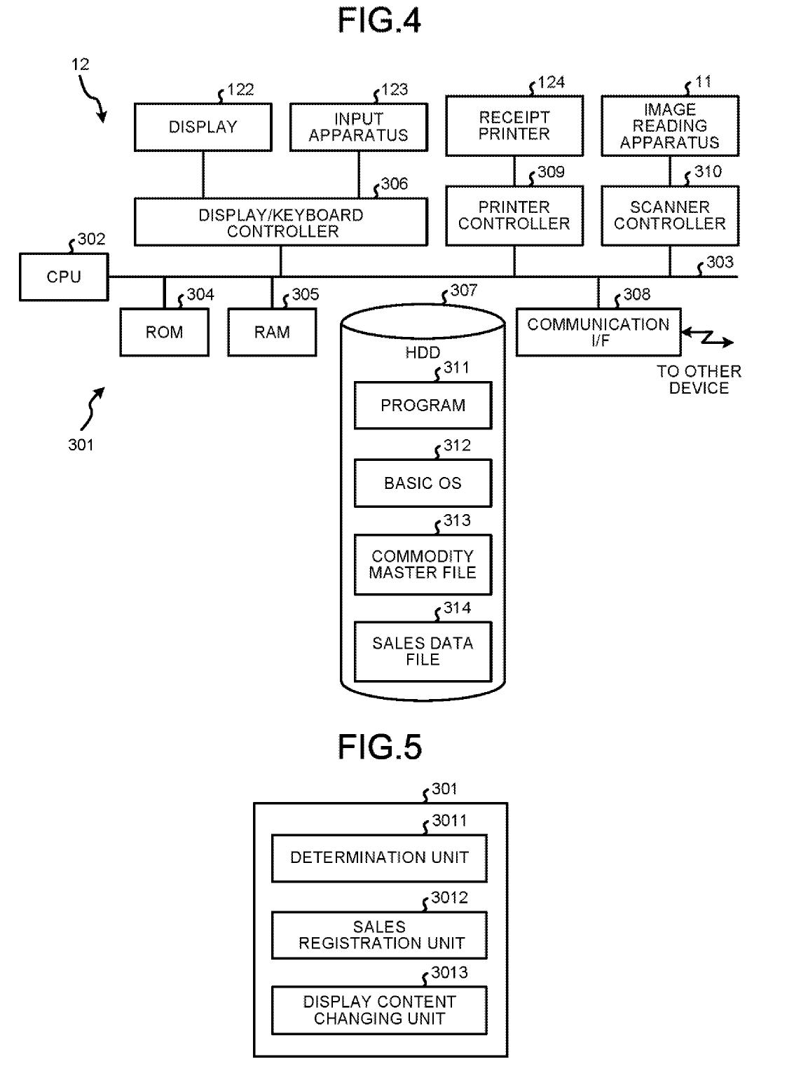

Next, the electric connection of the POS terminal 12 is described below. FIG. 4 is a block diagram illustrating the electric connection of the POS terminal 12. As shown in FIG. 4, the POS terminal 12 comprises a microcomputer 301 which drives and controls each section. The microcomputer 301 is constituted by connecting, through a bus line 303, a CPU (Central Processing Unit) 302 intensively controlling each section with a ROM (Read Only Memory) 304 storing fixed information such as a control program in advance and a RAM (Random Access Memory) 305 which stores various data in a rewritable manner and functions as a work area. Therefore, the microcomputer 301 constitutes an information processing section for executing an information processing. All or part of the RAM 305 is a non-volatile memory.

A display/keyboard controller 306, a HDD 307, a communication interface 308, a printer controller 309 and a scanner controller 310 are connected with the microcomputer 301 through the bus line 303.

Various data are stored in the HDD 307, for example, a basic OS 312, a program 311 for various processing in the POS terminal 12, a commodity master file 313 and a sales data file 314. The commodity master file 313 stores a price, a commodity name and the like in association with the commodity code. Further, the sales data file 314 stores sales data of one transaction together with a transaction number and a transaction category.

The display/keyboard controller 306 drives and controls the display 122 based on image data, displays an image corresponding to the image data on the display 122, and furthermore, acquires an input signal from the input apparatus 123 into the microcomputer 301. The communication interface 308 can carry out, through a LAN cable 108, data communication with other devices.

The printer controller 309 drives and controls the receipt printer 124 based on printing data, and enables the receipt printer 124 to print an image corresponding to the printing data.

The scanner controller 310 acquires an input signal from the image reading apparatus 11 into the microcomputer 301, and drives and controls the display 19 and the display for customer 20 based on the image data, and then displays an image corresponding to the image data on the display 19 and the display for customer 20.

Then, in the various processing executed by the microcomputer 301 of the POS terminal 12 according to the basic OS 312 and the program 311, the sales registration processing is described.

As shown in FIG. 5, the microcomputer 301 of the POS terminal 12 functions as a determination unit 3011, a sales registration unit 3012, a display content changing unit 3013 by executing programs according to the basic OS 312 and the program 311.

The determination unit 3011 determines whether the display for customer 20 is placed vertically or horizontally. For example, the determination unit 3011 determines whether the display for customer 20 is placed vertically or horizontally according to the output from the sensor S of the display for customer 20.

The sales registration unit 3012 executes the sales registration processing in response to the image (an image of a code symbol attached to a commodity or an object image of the whole commodity or a part of a commodity and the like) captured by the image capturing apparatus 17.

The display content changing unit 3013 changes, in response to a determination result based on the determination unit 3011, the display data of the sales registration processing carried out by the sales registration unit 3012 displayed on the display for customer 20. For example, in a case where the determination result based on the determination unit 3011 indicates that the display for customer 20 is placed vertically, the display content changing unit 3013 generates an electronic image of the transaction detail corresponding to the sales registration processing and displays the electronic image on the display for customer 20. The transaction detail includes, for example, a commodity name, a price, a total amount and the like. The display content changing unit 3013 displays the electronic image of the transaction detail on the display for customer 20 in a period from a moment when the sales registration processing is carried out to a moment when the transaction is determined at least. In a case where the determination result based on the determination unit 3011 indicates that the display for customer is placed vertically, and there are a plurality of commodities to be read, the display content changing unit 3013 displays commodity names of the plurality of commodities and prices corresponding to the plurality of commodities on the display for customer 20 until the transaction is determined. The transaction detail may be displayed until one transaction is ended.

In a case where the determination result based on the determination unit 3011 indicates that the display for customer 20 is placed horizontally, the display content changing unit 3013 displays the information of the commodity subjected to the sales registration processing on the display for customer 20. In a case where the determination result based on the determination unit 3011 indicates that the display for customer 20 is placed horizontally, the display content changing unit 3013 displays, for example, the commodity name and the price information of one commodity subjected to the sales registration processing on the display for customer 20. In a case where the determination result based on the determination unit 3011 indicates that the display for customer 20 is placed horizontally, and there are a plurality of commodities to be read, the display content changing unit 3013 may also display the total amount in addition to the commodity name and the price information of one commodity subjected to the sales registration processing.

In addition, the basic OS 312 and the program 311 executed by the POS terminal 12 of the present embodiment are recorded in a computer-readable recording medium such as CD-ROM, flexible disk (FD), CD-R, DVD (Digital Versatile Disk) and the like in the form of installable or executable file.

Furthermore, the basic OS 312 and the program 311 executed by the POS terminal 12 of the present embodiment may be stored in a computer connected with a network such as the internet, and downloaded via the network. Further, the basic OS 312 and the program 311 executed by the POS terminal 12 of the present embodiment may also be provided or distributed via a network such as the internet.

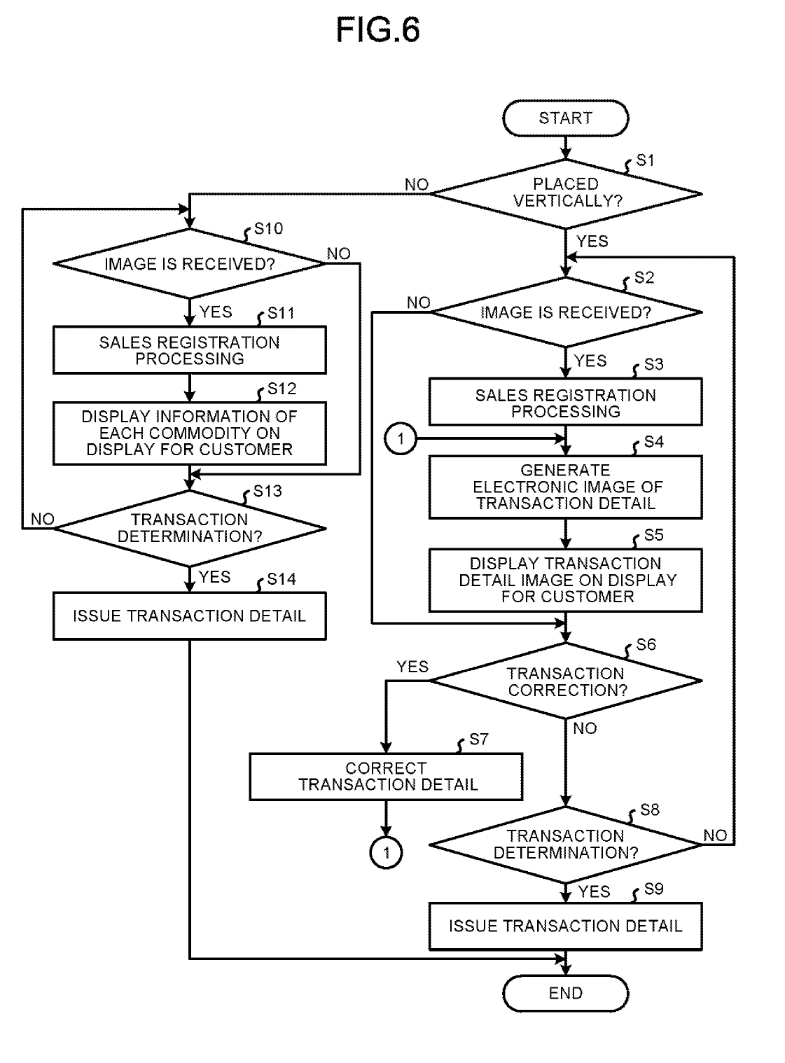

FIG. 6 is a flowchart illustrating one example of a flow of the sales registration processing carried out by the POS terminal 12. One example of the sales registration processing is described based on the flowchart shown in FIG. 6.

The microcomputer 301 (determination unit 3011) of the POS terminal 12 determines whether or not the display for customer 20 is placed vertically (ACT S1) . That whether or not the display for customer 20 is placed vertically can be determined according to the output from the sensor S which determines whether the display for customer 20 is placed vertically or horizontally.

If it is determined that the display for customer 20 is placed vertically (YES in ACT S1), and if a captured image (an image of a code symbol attached to a commodity or an object image of the whole commodity or a part of a commodity and the like) sent from the image reading apparatus 11 is received (YES in ACT S2), the microcomputer 301 (sales registration unit 3012) of the POS terminal 12 specifies a commodity corresponding to the image through a comparison with the data of the commodity master file 313, and executes the sales registration processing for each specified commodity (ACT S3).

Next, the microcomputer 301 (display content changing unit 3013) of the POS terminal 12 generates an electronic image of the transaction detail (commodity name, price, total amount and the like) corresponding to the sales registration processing (ACT S4), and displays the transaction detail (commodity name, price, total amount and the like) serving as the electronic image generated in ACT S4 on the display for customer 20 of the image reading apparatus 11 (ACT S5).

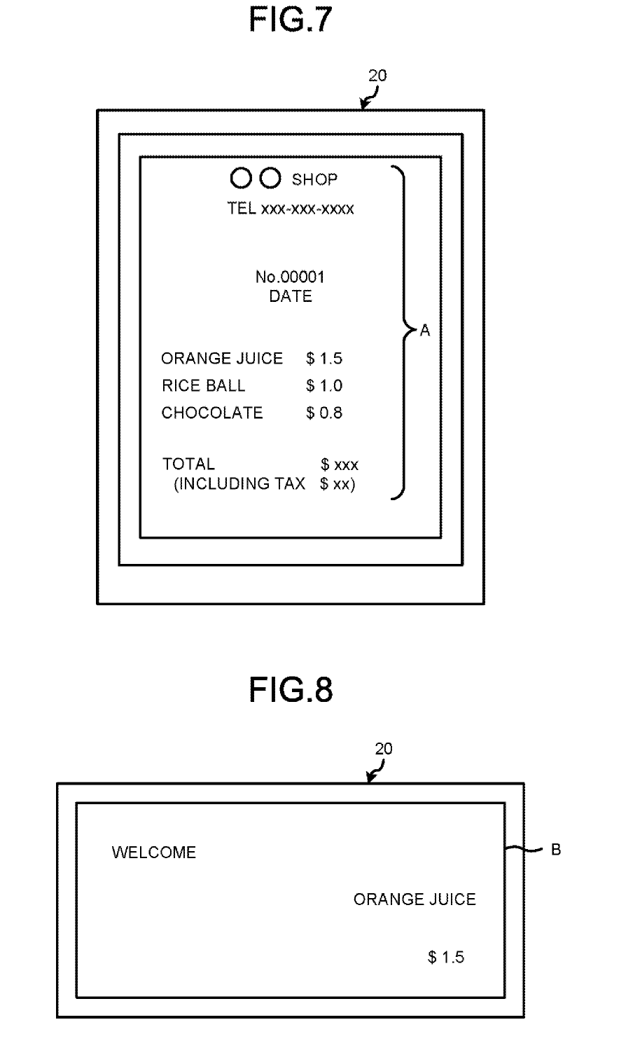

FIG. 7 is a front view illustrating a display example in a case where the display for customer 20 is placed vertically. As shown in FIG. 7, the vertically placed display for customer 20 displays a transaction detail (commodity name, price, total amount and the like) A corresponding to the sales registration processing. In addition to the commodity name, price and total amount, for example, a store name, contact information of a store, slip number, member number, transaction date and various messages may also be displayed. In addition, the commodity name, price and the like are not limited to be displayed in a single color and single size, and the color, the size and the background color of characters may be changed according to different information to be displayed.

That is, the shopper can confirm the transaction detail before the transaction is determined. Herein, in a case where the shopper noticed a commodity purchased by mistake, or that a commodity which is not desired to be purchased is registered due to an incorrect operation of the operator, the shopper can inform the operator to make a correction on the transaction.

If it is determined that a transaction correction key (not shown) of the keyboard 21 is operated and a transaction correction is declared (YES in ACT S6), the microcomputer 301 of the POS terminal 12 corrects the transaction detail (commodity name, price and the like) corresponding to the sales registration processing according to the operation of the operator (ACT S7), and then creates an electronic image of the corrected transaction detail (commodity name, price and the like) (ACT S4).

The microcomputer 301 of the POS terminal 12 repeats the processing from ACT S2 to ACT S7 until a closing key (not shown) of the keyboard 21 is operated and the transaction is determined (NO in ACT S8).

If the closing key (not shown) of the keyboard 21 is operated and the transaction determination is declared (YES in ACT S8), the microcomputer 301 of the POS terminal 12 prints and outputs the transaction detail (receipt) the same as the transaction detail displayed on the vertically placed display for customer 20 from the receipt printer 124 (ACT S9), and then ends the processing.

On the other hand, if it is determined that the display for customer 20 is placed horizontally (NO in ACT S1), and if a captured image (an image of a code symbol attached to a commodity or an object image of the whole commodity or a part of a commodity and the like) sent from the image reading apparatus 11 is received (YES in ACT S10), the microcomputer 301 (sales registration unit 3012) of the POS terminal 12 specifies a commodity corresponding to the image through a comparison with the data of the commodity master file 313, and executes the sales registration processing for each specified commodity (ACT S11).

Next, the microcomputer 301 (display content changing unit 3013) of the POS terminal 12 displays the information such as the commodity name, price and the like of the commodity subjected to the sales registration processing on the display for customer 20 of the image reading apparatus 11 (ACT S12).

FIG. 8 is a front view illustrating a display example in a case where the display for customer 20 is placed horizontally. As shown in FIG. 8, the horizontally placed display for customer 20 displays data B, such as the commodity name, price and the like of the commodity subjected to the sales registration processing. In addition to the commodity name and price of the commodity, various messages may also be displayed. In addition, the commodity name, price and the like of the commodity are not limited to be displayed in a single color and single size, and the color, the size and the background color of characters may be changed according to different information to be displayed.

Return to FIG. 6, the microcomputer 301 of the POS terminal 12 repeats the processing from ACT S10 to ACT S12 until the closing key (not shown) of the keyboard 21 is operated and the transaction determination is declared (NO in ACT S13).

If the closing key (not shown) of the keyboard 21 is operated and the transaction determination is declared (YES in ACT S13), the microcomputer 301 of the POS terminal 12 prints and outputs the transaction detail (receipt) from the receipt printer 124 (ACT S14), and then ends the processing.

In this way, according to the present embodiment, by displaying the transaction detail in advance for the customer desiring to confirm the transaction detail before checkout processing, the labor of returning the commodity can be reduced and the incorrect registration of the operator can be noticed in time. Further, by switching the placement method of the display for customer 20 to display the information of each commodity, a store may not need to purchase a display apparatus for displaying detail image and a display apparatus for displaying information of each commodity; the store can use one display apparatus to display both the detail image and the information of each commodity.

In addition, in the present embodiment, that whether or not the display for customer 20 is placed vertically is determined according to the output from the sensor S, however, it is not limited to this. A setter may visually determine whether or not the display for customer 20 is placed vertically by sight, and change the setting of ‘screen display method’ included in the basic OS 312 or the program 311. For example, in the setting screen (not shown) of the ‘screen display method’, buttons are displayed for selecting whether to place the display for customer 20 vertically or horizontally, and the setter selects the button according to the result of the visual determination on whether or not the display for customer 20 is placed vertically. In this case, the microcomputer 301 (determination unit 3011) of the POS terminal 12 determines whether or not the display for customer 20 is placed vertically by determining which one of the ‘vertically’ and ‘horizontally’ is selected in the setting screen. In addition, the setting changing through manual operation and the sensor S for determining whether the display for customer 20 is placed vertically or horizontally may be used together.

In the description above, the display for customer 20 is exemplified which can be placed vertically or horizontally through rotation, however, it is not limited to this. The display for customer 20 may also be arranged to be detachable from a fixed position (not shown). When desiring to change the angle of the display for customer 20, a user may detach the display for customer 20 from the fixed position, and then fix the display for customer 20 with a fixing member in a state where the angle of the display for customer 20 is changed. The fixing member may be, for example, a screw and a bolt.

Further, in the description above, the display for customer which changes the display when placed vertically or horizontally is carried on the image reading apparatus 11 serving as a vertical scanner, however, it is not limited to this . The display for customer 20 which changes the display when placed vertically or horizontally may also be carried on the POS terminal 12 serving as a commodity sales data processing apparatus.

Furthermore, the POS system 1 of the present embodiment is a system in which the image reading apparatus 11 serving as a vertical scanner and the POS terminal 12 serving as a commodity sales data processing apparatus for executing a sales registration processing in response to an image captured by the image reading apparatus 11 are constituted separately, however, the present invention is not limited to this. The POS system 1 may also be a system in which the image reading apparatus 11 serving as a vertical scanner is integrated with the POS terminal 12 serving as a commodity sales data processing apparatus for executing a sales registration processing in response to an image captured by the image reading apparatus 11.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A store system, comprising:
an image capturing apparatus configured to optically capture an image through an image capturing window;
a display for customer configured to be selectively arranged in a horizontal or vertical manner at a side opposite to a side where the image capturing window is arranged to display the display data;
a determination unit configured to determine whether the display for customer is placed vertically or horizontally;
a sales registration unit configured to execute a sales registration processing in response to an image captured by the image capturing apparatus; and
a display content changing unit configured to change, in response to a determination result based on the determination unit, the display data of the sales registration processing carried out by the sales registration unit displayed on the display for customer.

2. The store system according to claim 1, wherein
the display content changing unit generates, in a case where the determination result based on the determination unit indicates that the display for customer is placed vertically, an electronic image of transaction detail corresponding to the sales registration processing, and displays the electronic image on the display for customer.

3. The store system according to claim 1, wherein
the display content changing unit displays, in a case where the determination result based on the determination unit indicates that the display for customer is placed horizontally, information of a commodity subjected to the sales registration processing on the display for customer.

4. The store system according to claim 1, wherein
the display for customer includes a vibration type gyroscope; and
the determination unit determines whether the display for customer is placed vertically or horizontally according to an output from the vibration type gyroscope.

5. The store system according to claim 1, comprising:
an image reading apparatus configured to include the image capturing apparatus and the display for customer; and
a commodity sales data processing apparatus configured to include the determination unit, the sales registration unit and the display content changing unit.
